(19) United States
(12) Patent Application Publication
(10) Pub. No.: US 2010/0118329 A1
(43) Pub. Date: May 13, 2010

(54) Image forming apparatus and image forming method

(75) Inventors: Daisuke Fujiki, Yamatokoriyama-Shi (JP); Yukihito Nishio, Ikoma-Gun (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/657,113

(22) Filed: Dec. 9, 2009

(30) Foreign Application Priority Data
Dec. 18, 2007 (JP) 2007-326351

(51) Int. Cl. G06K 15/02

(52) U.S. Cl. 358/1.14; 358/1.15; 358/1.16

(57) ABSTRACT

An image forming apparatus includes: a LAN I/F for communication with external devices through a network; a printer engine for executing printing; an HDD for storing file name and transmission source information of printed data; a CPU executing, if the LAN I/F receives a print instruction of data having the same file name and same transmission source as data stored in the HDD, a program for detecting wasteful printing, based on match rate of the received data with respect to the printed data and on accumulated number of printed copies related to the transmission source; and an engine I/F for transmitting data and the like to the printer engine, under the control of CPU.

### CROSS-REFERENCE TO RELATED APPLICATION

This nonprovisional application claims priority under 35 U.S.C. §119(a) on Patent Application No. 2007-326351 filed in Japan on Dec. 18, 2007, the entire contents of which are hereby incorporated by reference.

### BACKGROUND OF THE INVENTION

1. Field of the Invention

The present invention relates to an image forming apparatus connected to a network and, more specifically, to a technique for reducing wasteful printing.

2. Description of the Background Art

In these days, a printing system including a terminal such as a PC (Personal Computer) and a printer communicable with the terminal is growing popular. Frequent occurrence of wasteful printing has been acknowledged as a problem of the printer in the printing system. The wasteful printing refers to repeated execution of unnecessary print-out instructions, when a user operating the terminal inputs print instructions of one same data repeatedly by mistake. When a user forms data on the terminal, he/she may make minor corrections on the data repeatedly for polishing, for example, and may print the data repeatedly. Depending on the number of corrections, the number of printed sheets of paper and the frequency of printing, such practice of the user may also result in wasteful printing. In the following, such actions of the user will generally be referred to as wasteful printing.

Wasteful printing wastes printing cost, including ink, paper and so on. If the printing system is a part of a network in which one printer is shared by a plurality of terminals, wasteful printing increases the risk of the printer being kept busy. This may prevent smooth printing, possibly lowering operational efficiency or performance of a company or an organization.

As a solution to such a problem, Japanese Patent Laying-Open No. 2005-125646 proposes an image forming apparatus such as a printer, connected to a plurality of PCs, for preventing wasteful printing. When a print instruction for printing image data of one file name is issued twice within ten minutes from one PC, the image forming apparatus notifies the PC that print instruction of data of the same file name has been successively sent twice. Receiving the notice, the PC displays a window asking the user to select whether the second printing is to be executed by the image forming apparatus or not. The PC user selects whether the second printing process is to be executed by the image forming apparatus or not on the window, and inputs the result of selection to the PC. The PC transmits the result of selection to the image forming apparatus. Depending on the result of selection received from the PC, the image forming apparatus executes the printing process. By the above-described arrangement, wasteful printing can be prevented and only the necessary printing is activated.

According to the technique disclosed in Japanese Patent Laying-Open No. 2005-125646, when print instruction of image data of the same file name is issued from the same PC within ten minutes from an execution of a printing process, notification that print instruction of the same file name has been successively sent twice and selection by the user to activate/inactivate the second printing always take place. The technique disclosed in Japanese Patent Laying-Open No. 2005-125646, however, has the following problem. Typically, repeated printing of data of the same file name frequently becomes necessary when, for example, necessary distribution increases. In that case, the action for repeated printing is not wasteful. If the notice is received from the image forming apparatus to urge user selection every time one instructs not-wasteful printing of data of the same file name twice or more, operation would be more bothering to the user.

When viewed from a different point, the image forming apparatus described in Japanese Patent Laying-Open No. 2005-125646 simply checks whether there has been a print instruction having the same file name coming from the same PC, in order to determine whether the same print instruction has been made or not. That the data has the same file name and transmitted from the same PC does not mean that the image data as the object of printing is the same. It is well expected that a first print instruction is issued, that the image data of the same file name is corrected significantly within ten minutes thereafter, and that a print instruction is issued again with the same file name. Such a series of operations is not at all wasteful for the user. The technique disclosed in Japanese Patent Laying-Open No. 2005-125646 forces the user to do the troublesome work described above even in such a situation of non-wasteful printing.

### SUMMARY OF THE INVENTION

Therefore, an object of the present invention is to provide a technique of reducing wasteful printing without necessitating troublesome work by the user, in an image forming apparatus communicating with a terminal and printing data formed on the terminal.

Another object of the present invention is to provide a technique that allows printing without bothering the user if printing is not wasteful and reduces wasteful printing by letting the user be aware of wasteful printing if the printing is wasteful, in an image forming apparatus communicating with a terminal and printing data formed on the terminal.

A further object of the present invention is to provide a technique allowing reduction of wasteful printing while maintaining operation efficiency, by effectively addressing to a user who repeats wasteful printing while not unfavorably affecting a user not doing wasteful printing, in an image forming apparatus communicating with a terminal and printing data formed on the terminal.

According to a first aspect, the present invention provides an image forming apparatus, including: a receiving unit receiving data as an object of printing from a terminal; a printer printing data as an object of printing; a first determining unit coupled to the receiving unit and the printer, for determining, by comparing contents of new data as an object of printing newly received by the receiving unit and contents of printed data having the same file name as the new data and having the same identifier of a transmission source terminal as the new data, among the data already printed by the printer, whether the new data is to be printed immediately or not; and a print controller connected to the printer and the first determining unit, for executing, depending on whether it is determined by the first determining unit that the new data is not to be printed immediately, a prescribed process for determining whether printing of the new data is to be executed or not, and controlling the printer in accordance with the result of the process.

When the receiving unit receives data as an object of printing from a terminal, the first determining unit searches for any printed data having the same file name as the new data and having the same identifier of a transmission source terminal as the new data, among the data already printed by the printer. If there is any such printed data, the first determining unit compares contents of the printed data and the new data, and determines whether the new data is to be printed immediately or not. Depending on the determination by the first determining unit to print immediately or not, the printer controller performs the prescribed process to determine whether printing of the new data is to be executed or not. The printer controller controls the printer in accordance with the result of the process. It is noted that in the present specification, “immediately” does not mean “continuous in terms of time.” In the present specification, “immediately” means that, when printing is determined not to be wasteful, no other determination as to whether printing should be done or not is made before actual printing.

Specifically, in the present image forming apparatus, if data of the same file name as printed data is received from the same terminal, whether the printing is wasteful or not is determined in consideration of degree of correction of the data as the object of printing with respect to the printed data. If it is determined to be wasteful printing, execution/non-execution is determined depending on the result of the prescribed process. Consequently, wasteful printing can be reduced, while the user is not forced to do troublesome work.

Preferably, the first determining unit includes a storage unit coupled to the printer, for storing print history as a combination of data already printed by the printer, a file name of the data and an identifier of a terminal as a transmission source of the data, and a second determining unit coupled to the receiving unit and the storage unit, for determining, by comparison between contents of the new data and of the printed data having the same file name and the same identifier of transmission source terminal as the new data among the print history stored in the storage unit, whether or not the new data is to be printed immediately.

The storage unit stores print history including a set of printed data that has been printed by the printer, file name of the data, and an identifier of a terminal as the transmission source of the data. The second determining unit compares the contents of the new data with the contents of the printed data that has the same file name and transmitted from the same transmission source terminal as the new data, in the print history stored in the storage unit, and thereby determines whether the new data is to be printed immediately or not.

As the data already printed by the printer are stored in the storage unit, what is necessary for the second determining unit is simply to extract data satisfying conditions from among the printed data stored in the storage unit, when the contents of the new data and of the printed data are to be compared.

More preferably, the image forming apparatus further includes a control unit connected to the printer and the first determining unit, for causing the printer to print the new data, in response to a determination by the first determining unit that the new data is to be printed immediately.

In response to the determination by the first determining unit to print the new data immediately, the control unit controls the printer such that the new data is printed. Therefore, the user of image forming apparatus can immediately confirm the printout of the data as the object of printing, which is determined to be printed immediately.

More preferably, the first determining unit includes a match rate calculating unit coupled to the receiving unit and the printer, for calculating match rate between contents of the new data and contents of printed data having the same file name as the new data and having the same identifier of the transmission source terminal as the new data, among the data already printed by the printer, and a unit coupled to the match rate calculating unit for determining whether or not the new data is to be printed immediately, depending on whether the match rate calculated by the match rate calculating unit is equal to or higher than a prescribed threshold value.

If there is any printed data having the same file name and having the same identifier of the transmission source terminal as the new data, the match rate calculating unit calculates the match rate, which indicates the degree how much the contents of the data as the object of printing matches the contents of the printed data. Depending on whether the match rate is equal to or higher than the prescribed threshold value, the unit for determining determines whether or not the printing is wasteful or not. If it is determined to be wasteful printing, execution/non-execution is determined depending on the result of the prescribed process. Specifically, the present image forming apparatus determines whether the printing is wasteful or not in consideration of the number of corrections of the data. Consequently, wasteful printing can be reduced, while the user is not forced to do troublesome work.

More preferably, the printer controller includes a transmitting unit coupled to the first determining unit, for transmitting, in response to a determination by the first determining unit that the new data is not to be printed immediately, a signal inquiring whether printing of the new data is to be executed or not, to the transmission source terminal of the new data, and a control unit coupled to the printer, for controlling the printer in accordance with an instruction returned from the transmission source terminal in response to the signal.

If it is determined by the first determining unit that the data as the object of printing is not to be immediately printed, a signal asking whether printing of the data is to be executed or not is transmitted by the transmitting unit to the transmission source terminal. When the transmission source terminal receives this and the user of the transmission source terminal applies an instruction to execute/suspend printing, the instruction is returned to the image forming apparatus. The control unit controls the printer in accordance with the instruction.

The image forming apparatus inquires, to the transmission source terminal of the data as the object of printing that is determined to be wasteful, whether printing is to be executed or not, and receives a user instruction. Therefore, the user who instructed printing may prevent wasteful printing by inputting an instruction to suspend the printing, or he/she may instruct execution of the printing to have the necessary data printed. In addition, that the user is notified of possible wasteful printing is effective to encourage the user of the terminal to reduce wasteful printing. As a result, an image forming apparatus that allows printing without bothering the user if printing is not wasteful printing and that reduces wasteful printing by letting the user be aware of wasteful printing if the printing is wasteful, can be provided.

More preferably, the printer controller includes an accumulated number calculating unit, coupled to the printer and the first determining unit, for calculating an accumulated number of printed copies of the printed data having the same file name as the new data and the same identifier of the transmission source terminal as the new data, among the data already printed by the printer, in response to a determination by the first determining unit that the new data is not to be printed immediately, a second determining unit coupled to the accumulated number calculating unit for determining whether or not the new data is to be printed immediately, depending on whether the accumulated number calculated by the accumulated number calculating unit is larger than a prescribed threshold value or not, a transmitting unit coupled to the second determining unit, for transmitting, in response to a determination by the second determining unit that the new data is not to be printed immediately, a signal inquiring whether printing of the new data is to be executed or not, to the transmission source terminal of the new data, and a control unit coupled to the printer, for controlling the printer in accordance with an instruction returned from the transmission source terminal in response to the signal.

The first determining unit compares contents of the new data with the contents of printed data having the same file name and the same identifier of the transmission source terminal as the new data, among the data already printed by the printer. Based on the comparison of contents, if it is determined by the first determining unit that the data as the object of printing is not to be printed immediately, the accumulated number calculating unit calculates the accumulated number of printed copies of the printed data of interest. Depending on whether the accumulated number of printed copies is larger than the prescribed threshold value or not, the second determining unit determines whether the data as the object of printing is to be printed immediately or not. If the new data involves wasteful printing and the accumulated number of printed copies thereof exceeds the threshold value, the transmitting unit transmits a signal inquiring whether printing of the data is to be executed or not, to the transmission source terminal. In response, the user is requested to input an instruction to execute/suspend printing. The control unit receives the instruction and controls the printer in accordance with the instruction.

The image forming apparatus of the present invention does not promptly give a notice of wasteful printing to the user, even if wasteful printing is detected. In that case, the accumulated number calculating unit calculates the accumulated number of printed copies, indicating how many copies of wasteful printing has been done, of the data having the same file name as the new data and coming from the same transmission source terminal as the new data. The second determining unit determines whether the accumulated number of printed copies is larger than the threshold value or not. If it is the case that wasteful printing of data of the same file name has been done time and again from the same terminal and the accumulated number of copies of wasteful printing exceeds the threshold value, a process for preventing wasteful printing may be performed, rather than immediately executing printing. Notice of wasteful printing to the user is given less frequently. Further, once the accumulated number of printed copies of wasteful printing exceeds the threshold value and wasteful printing is about to be done, the process for reducing wasteful printing is performed without exception.

If wasteful printing is detected from the accumulated number of printed copies and the degree of data correction, and if the accumulated number of printed copies exceeds the threshold value, the transmitting unit inquires to the transmission source terminal whether the printing of the data is to be executed or not. Therefore, if the accumulated number of printed copies is small, it is unnecessary for the user to frequently issue an instruction of executing/suspending printing. If the accumulated number of printed copies becomes larger than the threshold value, the user of the terminal that instructed printing must instruct whether the printing is to be executed or not, by himself/herself. It is possible for the user to prevent wasteful printing by instructing suspension, or to execute printing, if he/she believes the printing is necessary. Therefore, the user faces troublesome work less frequently, while notice received by the user is effective to encourage the user to reduce wasteful printing.

As a result, with the use of the image forming apparatus of the present invention, the user receives the notice for reducing wasteful printing less frequently when he/she forms a document and the user may be freed from troublesome work. Once the accumulated number of copies of wasteful printing exceeds the threshold value, a notice to reduce wasteful printing is received every time possibly wasteful printing is to be done. As a result, frequency of bothering work to the user can be reduced, while wasteful printing can be reduced efficiently.

More preferably, the printer controller includes: a memory; an area ensuring unit coupled to the receiving unit and the memory, for ensuring, in response to reception by the receiving unit of a combination of a certain file name and a certain identifier of a transmission source terminal, an area corresponding to the combination of the file name and the identifier of the transmission source terminal, and initializing a value of the area with a prescribed value; an adding unit coupled to the first determining unit and the memory, for adding, in response to a determination by the first determining unit that the new data is not to be printed immediately, a prescribed constant to a value stored in a first area ensured in the memory in association with the file name of the data and the identifier of the transmission source terminal of the data; a second determining unit coupled to the memory, for determining whether or not the value in the first area has exceeded a threshold value; a transmitting unit coupled to the second determining unit, for transmitting, in response to a determination by the second determining unit that the value has exceeded the threshold value, a signal inquiring whether printing of the new data is to be executed or not, to the transmission source terminal of the new data; and a control unit coupled to the printer, for controlling the printer in accordance with an instruction returned from the transmission source terminal in response to the signal.

When the receiving unit receives new data as the object of printing, the area ensuring unit ensures in the memory an area for storing a numerical value in correspondence with a combination of the file name of the data and the identifier of the transmission source terminal of the data, and initializes the area. When the first determining unit determines that the data as the object of printing is not to be printed immediately, the adding unit adds the prescribed constant to the memory area that corresponds to the file name of the data and the identifier of the transmission source terminal. If the second determining unit detects that the value stored in the memory area after addition has exceeded a certain threshold value, the transmitting unit transmits a signal asking whether the printing of data is to be executed or not, to the transmission source terminal. In response to the signal, the user of transmission source terminal inputs an instruction to execute/suspend printing. Receiving the instruction from the terminal, the control unit controls the printer in accordance with the instruction.

Every time wasteful printing is detected, the number of wasteful printing operations related to the file name and the identifier of the transmission source terminal is counted in correspondence with the file name and the identifier of the transmission source terminal, by the area ensuring unit and the adding unit. Printing is simply executed until this value exceeds the certain threshold value. If the threshold value is exceeded, however, an inquiry is made to the user of the transmission source terminal as to whether printing of the data is to be executed or not. It is necessary for the user to give an instruction to execute or to suspend printing. By such an arrangement, printing is executed without any inquiry as to whether printing is to be done or not, up to a certain number of times, even if the printing is wasteful. Once the number of wasteful printing operations exceeds the threshold value, however, the user of the terminal comes to frequently receive the inquiry as to whether printing is to be done or not. Therefore, to a user who frequently repeats wasteful printing many times, effective notice for reducing wasteful printing can be given. A user who does not much repeat wasteful printing hardly receives such a notice. As a result, the image forming apparatus that does not unfavorably affect a user not doing wasteful printing while effectively addressing to a user who repeats wasteful printing can be provided.

More preferably, the printer controller further includes a re-initializing unit coupled to the memory, for re-initializing the value of the first area with the prescribed value, in response to an instruction to suspend printing returned from the transmission source terminal in response to the signal.

In return to the inquiry as to whether the printing is to be executed or not, when an instruction to suspend printing is received from the transmission source terminal, the re-initializing unit initializes the memory area that corresponds to the file name and the transmission source terminal of the data. Therefore, the user who once suspended wasteful printing does not receive the inquiry as to whether the printing is to be executed or not for some time. As a result, an image forming apparatus that can maintain work efficiency of the user while reducing wasteful printing can be provided.

More preferably, the match rate calculating unit includes: a selecting unit coupled to the receiving unit and the printer, for successively selecting each of printed data having the same file name as the new data and having the same identifier of a transmission source terminal as the new data, among data already printed by the printer; a dividing unit coupled to the selecting unit, for equally dividing data selected by the selecting unit into blocks of a prescribed size; a match determining unit coupled to the dividing unit, for determining, for each of the blocks divided by the dividing unit, whether or not a matching block exists in the new data; and a unit coupled to the selecting unit, the dividing unit and the match determining unit, for calculating, as the match rate, ratio between a total number of blocks divided by the dividing unit and the number of blocks that are determined by the match determining unit to have matching block in the new data, for the data selected by the selecting unit.

If there is any printed data having the same file name as the new data and having the same identifier of a transmission source terminal as the new data, among the data already printed by the printer, the selecting unit selects the printed data. The dividing unit equally divides the printed data into blocks of a prescribed size. The match determining unit determines, for each of the blocks of printed data stored in the dividing unit, whether there is any matching block in the data as the object of printing. The calculating unit calculates the ratio between the number of blocks determined to be matching and the total number of blocks of the printed data as the match rate.

According to the image forming apparatus, when the amount of correction of the data instructed to be printed with respect to the printed data is small, the match rate is high, and if the amount of correction is large, the match rate becomes lower. Based on the match rate, the present apparatus detects wasteful printing. As the wasteful printing is detected based on the amount of correction to the data, it follows that a notice to reduce wasteful printing is given frequently to a user who prints after minor correction time and again, while such a notice is not given to a user who prints only after considerable corrections are made. As a result, work efficiency becomes higher for a user who does not much print wastefully, whereas an effective measure to reduce wasteful printing can be taken for the user who frequently executes wasteful printing. As a result, an image forming apparatus enabling reduction of wasteful printing can be provided.

More preferably, the image forming apparatus further includes a history deleting unit coupled to the storage unit for deleting a piece of print history that has been stored in the storage unit for more than a prescribed time period, from the print history.

After a prescribed time period, the print history is deleted. Therefore, relatively old print history is not reflected in determining whether the printing of received data as the object of printing is wasteful or not. Even if the amount of correction is small, printing may be necessary and not wasteful for the user if long time has passed from the last to the present printing. In that case, the user can execute necessary printing without receiving a notice of wasteful printing or making a selection to execute or suspend printing.

According to another aspect, the present invention provides an image forming method, including: receiving step of receiving data as an object of printing from a terminal; determining step of determining, by comparing contents of received data as an object of printing received at the receiving step with contents of printed data having the same file name as the received data and having the same identifier of a transmission source terminal as the received data among the data already printed by a printer, whether or not the received data is to be printed immediately or not; and printing step of executing, depending on whether it is determined at the determining step that the received data is not to be printed immediately, a prescribed process for determining whether printing of the received data is to be executed or not, and printing the received data in accordance with the result of the process.

Preferably, the determining step includes match rate calculating step of calculating match rate between contents of the received data and contents of printed data having the same file name as the received data and having the same identifier of the transmission source terminal as the received data, among the data already printed by the printer, and the step of determining whether or not the received data is to be printed immediately, depending on whether the match rate calculated at the match rate calculating step is equal to or higher than a prescribed threshold value.

According to a still further aspect, the present invention provides an image forming program causing, when executed by a computer, the computer to execute an image forming method including: receiving step of receiving data as an object of printing from a terminal; determining step of determining, by comparing contents of received data as an object of printing received at the receiving step with contents of printed data having the same file name as the received data and having the same identifier of a transmission source terminal as the received data, among the data already printed by a printer, whether or not the received data is to be printed immediately or not; and printing step of executing, depending on whether it is determined at the determining step that the received data is not to be printed immediately, a prescribed process for determining whether printing of the received data is to be executed or not, and printing the received data in accordance with the result of the process.

As described above, according to the present invention, wasteful printing is detected in accordance with the ratio of amount of correction of the print data. If it is not wasteful printing, printing is executed immediately, and if it is wasteful printing, determination is made as to whether printing is to be done or not. The determination as to whether printing is to be done or not is made based on the accumulated number of printed copies of wasteful printing, or accumulated number of wasteful printing operations. Until certain conditions are satisfied, printing is executed even if it is wasteful. After the certain conditions are satisfied, a process for reducing wasteful printing is performed every time wasteful printing is about to be done, without exception. The process for reducing wasteful printing is, for example, to give a notice to the user, and to request instruction to execute/suspend printing. As a result, according to the present invention, it becomes possible to maintain high work efficiency of the user and to reduce wasteful printing. Reduction of wasteful printing leads to reduction of wasteful cost related to printing, such as cost for ink and paper and, in addition, it prevents decrease in operational efficiency.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a system including an image forming apparatus 26 in accordance with the first embodiment of the present invention.

FIG. 2 is a flowchart representing a control structure of a main control program for wasteful printing detection, executed by a CPU 52 of image forming apparatus 26 shown in FIG. 1.

FIG. 3 is a flowchart representing a control structure of a program for calculating the match rate, activated in response to a determination of YES at step 84 shown in FIG. 2.

FIG. 4 is an illustration of a method of calculating match rate, by the program of which control structure is shown in FIG. 3.

FIG. 5 is a flowchart representing a control structure of a main control program for wasteful printing detection, executed by a CPU of the image forming apparatus in accordance with the second embodiment.

### DESCRIPTION OF THE PREFERRED EMBODIMENTS

In the following description of embodiments and in the drawings, the same components are denoted by the same reference characters and same names. Their functions are also the same. Therefore, detailed description thereof will not be repeated.

### First Embodiment

The image forming apparatus in accordance with the first embodiment of the present invention stores and holds print history, every time image data is printed. For every printing, the image forming apparatus stores, as the history of printing, the printed image data, file name of the data, the name of terminal as a source of transmission of a print instruction, and time of printing. When print instruction of data having the same file name is made twice from the same terminal, the image forming apparatus does not immediately print the received data. In such a case, the image forming apparatus compares the two print instructions. With respect to the two print instructions, the image forming apparatus calculates a match rate indicating how much the contents of image data match with each other. In the present embodiment, the match rate is calculated to assume a value of 0 to 100[%]. If similarity between the two image data is higher, the value of match rate becomes larger. The method of calculating the match rate will be described later.

In the present image forming apparatus, if the match rate between the newly received image data as the object of printing and the image data received in the past is high and if the accumulated number of printed copies is considerably large as the data of the same file name has been printed a number of times from the same transmission source PC, the printing is determined to be wasteful.

Therefore, in the present embodiment, for the determination of wasteful printing, threshold value is set for each of the result of calculation of match rate and the accumulated number of printed copies. If each of the match rate and the accumulated number of printed copies is equal to or higher than the threshold value, the image forming apparatus determines the printing to be wasteful. If it is determined to be wasteful printing, the image forming apparatus transmits, to the PC as the transmission source of print instruction, a notice of wasteful printing, and a signal to ask selection of activation/inactivation of the print instruction. If it is determined not to be wasteful printing, the image forming apparatus immediately prints the data.

In the present invention, the threshold value of match rate is determined in advance. Further, in the present embodiment, the threshold value of accumulated number of printed copies is a value obtained by subtracting, from a predetermined constant, the number of copies printed if the data of which printing is instructed should be printed. This is the same as determining whether or not the value, obtained by adding the number of copies printed if the data of which printing is instructed is printed to the accumulated number of printed copies, exceeds the threshold value as the prescribed constant. The accumulated number of printed copies represents accumulated total number of printed copies of data, having the same file name and transmitted from the same transmission source PC, which have already been printed.

If it is determined to be wasteful printing, the terminal receives, from the image forming apparatus, a notice that the printing is wasteful, the terminal displays a window asking the user to select whether the printing process is to be executed by the image forming apparatus or not, in connection with the print instruction that has been determined to be wasteful. The user selects either one, on the window. After the selection by the user, the result of selection is transmitted from the terminal to the image forming apparatus. Based on the result of selection by the user, the image forming apparatus activates/inactivates the print instruction of the data.

Therefore, different from the prior art, the image forming apparatus of the present invention does not, for every re-printing instruction, invoke troublesome work such as notice of wasteful printing and selection. Wasteful printing is detected in consideration of contents of the image data as the object of printing and, therefore, the image forming apparatus reduces wasteful printing, thereby reduces cost of paper and the like, and avoids operational delay.

—Structure—

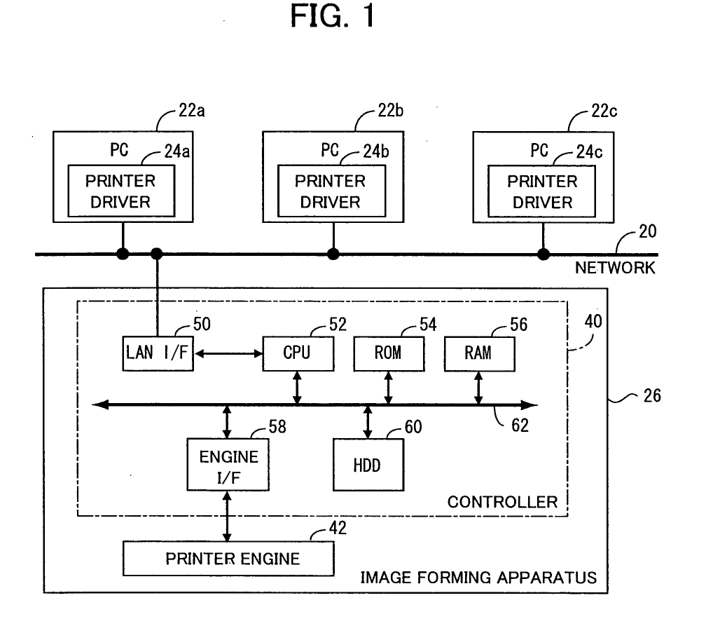

Referring to FIG. 1, an image forming apparatus 26 in accordance with the present embodiment is used connected to a network 20. To network 20, PCs 22a, 22b and 22c and the like are connected, and image forming apparatus 26 is capable of communicating with external devices such as PCs 22a, 22b and 22c. PCs 22a, 22b and 22c include print drivers 24a, 24b and 24c, respectively, each of which has a function of transmitting a print instruction to image forming apparatus 26 and causing execution of printing, a function of receiving an output signal from image forming apparatus 26 and displaying a window notifying that the print instruction sent second time corresponds to wasteful printing and displaying a window for asking selection of activating/inactivating the print instruction, and a function of transmitting the result of user selection of activation/inactivation to image forming apparatus.

To PCs 22a, 22b and 22c and the like, IDs (Identification Numbers) and network addresses allowing identification on the network are allotted by an administrator of the network 20.

In the following, an external device giving a print instruction to image forming apparatus 26 through the network will generally be referred to as a PC.

Image forming apparatus 26 includes a controller 40 connected to network 20 for performing a process for realizing printing in accordance with a print instruction from the PC, and a printer engine 42 connected to controller 40 for executing printing in accordance with an instruction from controller 40.

Controller 40 includes a LAN (Local Area Network) I/F (Interface) 50 connected to network 20 for transmitting/receiving data to/from the PC; a bi-directional bus 62; and a CPU (Central Processing Unit) 52 connected to LAN I/F 50 and bus 62, respectively, for executing a program for detecting wasteful printing in response to a print instruction from the PC received through LAN I/F 50 and giving a notice to the PC, and for activating/inactivating the print instruction in accordance with a selection by the user of the PC, and a program for realizing general functions of the image forming apparatus 26. Controller 40 further includes: an ROM (Read Only Memory) 54 connected to bus 62, for storing a boot-up program of image forming apparatus 26 and constants and the like used when CPU 52 executes a program; an RAM (Random Access Memory) 56 connected to bus 62; an HDD (Hard Disk Drive) 60 connected to bus 62 for storing data of which printing is instructed and related information, a program to be executed by CPU 52 and the like; and an engine I/F 58 connected to bus 62 and printer engine 42, respectively, for transmitting the image data as the object of printing transmitted from the PC and transmitting information related to printing to printer engine 42, under the control of CPU 52.

HDD 60 stores printed image data, file name of the data, ID and network address of the PC that issued the print instruction of the data, in correspondence with each other, as print history. By summing the number of printed copies of the print data having the same file name and the same PC ID, it is possible to calculate the accumulated number of printed copies of the data.

Receiving a print instruction, CPU 52 executes a main control program for wasteful printing detection. The process of the program will be briefly described. The main control program for wasteful printing detection first determines if the received print instruction corresponds to wasteful printing or not. If it corresponds to wasteful printing, the program notifies accordingly, to the PC as the transmission source of the print instruction. The program activates/inactivates the print instruction in accordance with a result of selection by the user of the PC. In the following, details of the process will be described.

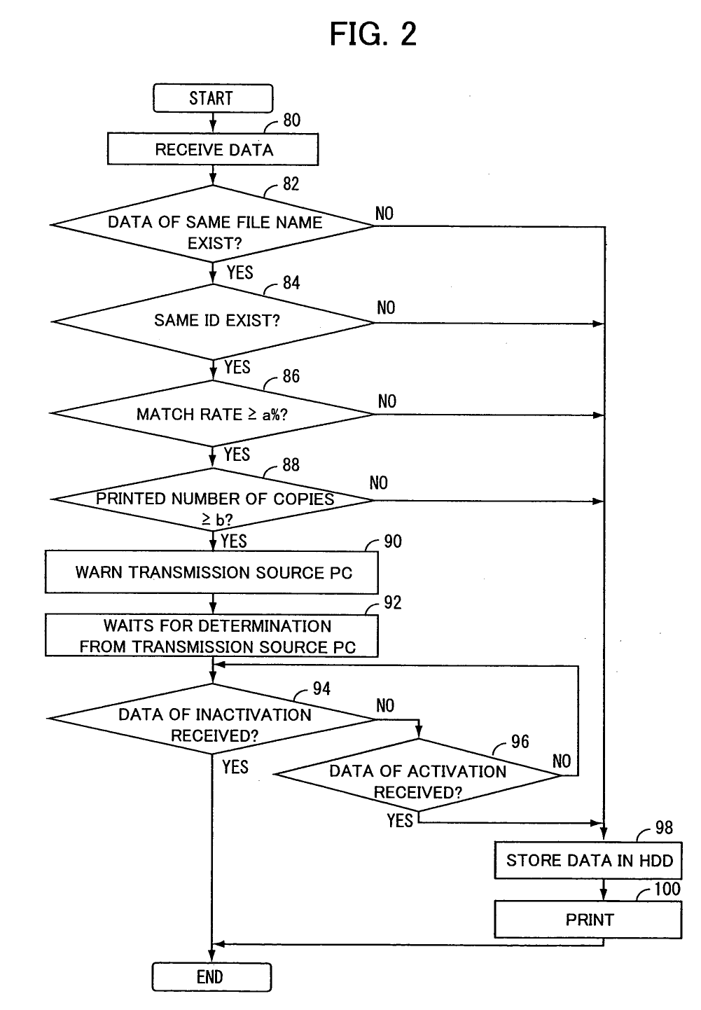

Referring to FIG. 2, the program includes, after activation, a step 80 of storing contents of print instruction received from the PC in RANI 56. At step 80, the program stores the image data as the object of printing, file name of the data, and ID and network address of the PC as the transmission source, from the print instruction, in RAM 56.

The program further includes a step 82 of determining whether or not print history of the same file name as the received file name exists in HDD 60 and branching the control flow depending on the result of determination; and a step 84, executed in response to a determination at step 82 that a print instruction having the same file name as received exists in HDD 60, of determining, for each of the print instruction of the same file name stored in HDD 60, whether the print instruction has been made by the ID of the same PC, and branching the control flow depending on the result of determination. The determination at step 84 is performed by comparing the ID of PC that transmitted the print instruction with the ID of PC that corresponds to the file name, extracted from HDD 60 using the received file name as a search key at step 82.

The program further includes a step 86, executed in response to the determination at step 84 that the newly received print instruction and the print instruction of the same file name stored in HDD 60 are both transmitted from the same PC, of calculating match rate between the image data of the same file name stored in HDD 60 and the newly received image data as the object of printing, determining whether the calculated match rate is equal to or higher than a threshold value a %, and branching the control flow depending on the result of determination. Details of the determination at step 86 will be described later.

The program further includes a step 88 executed in response to a determination at step 86 that the match rate is equal to or larger than a %, of comparing an accumulated number of printed copies of the printed data with a new threshold b, which is obtained by subtracting the number of copies to be printed in accordance with the newly received print instruction from a prescribed threshold value, determining whether the accumulated number of printed copies of the printed data is equal to or higher than the new threshold value b, and branching the control flow depending on the result of determination; a step 90 executed in response to a determination at step 88 that the accumulated number of printed copies is equal to or higher than b, of transmitting a warning that the print instruction corresponds to wasteful printing, to the network address of the PC as the transmission source; and a step 92 executed after step 90, of transmitting a signal to the network address of the PC as the transmission source of the newly received print instruction, to cause a window asking for an instruction of activation/inactivation of the print instruction to be displayed on the screen of the PC.

After step 92, the PC transmits to image forming apparatus 26 either the data of print instruction inactivation, indicating that the print process should not be executed in response to the print instruction that has been determined to be wasteful, or the data of print instruction activation, indicating that the print process should be executed in response to the print instruction that has been determined to be wasteful. Which of the data of print instruction inactivation/activation is transmitted from the PC is determined by the user of the PC.

The program further includes a step 94 executed after step 92, of determining whether the print instruction inactivation data has been received from the PC as the transmission source, and ending the process if the data of print instruction inactivation has been received; a step 96 executed in responses to a determination at step 94 that the data of print instruction inactivation has not been received, of determining whether the data of print instruction activation has been received from the PC as the transmission source, and returning the process to step 94 if the data of print instruction activation has not been received; a step 98 executed in response to the determination of NO at step 82, 84, 86 or 88 or in response to the determination at step 96 that the data of print instruction activation has been received, of developing the newly received image data as the object of printing to a printable form, and storing the image data, file name of the data, the ID and network address of the PC that transmitted the print instruction, all in related manner, in HDD 60; and a step 100 executed after step 98 of transmitting the image data as the object of printing developed at step 98 to printer engine 42 through engine I/F 58, executing the print process and ending the process.

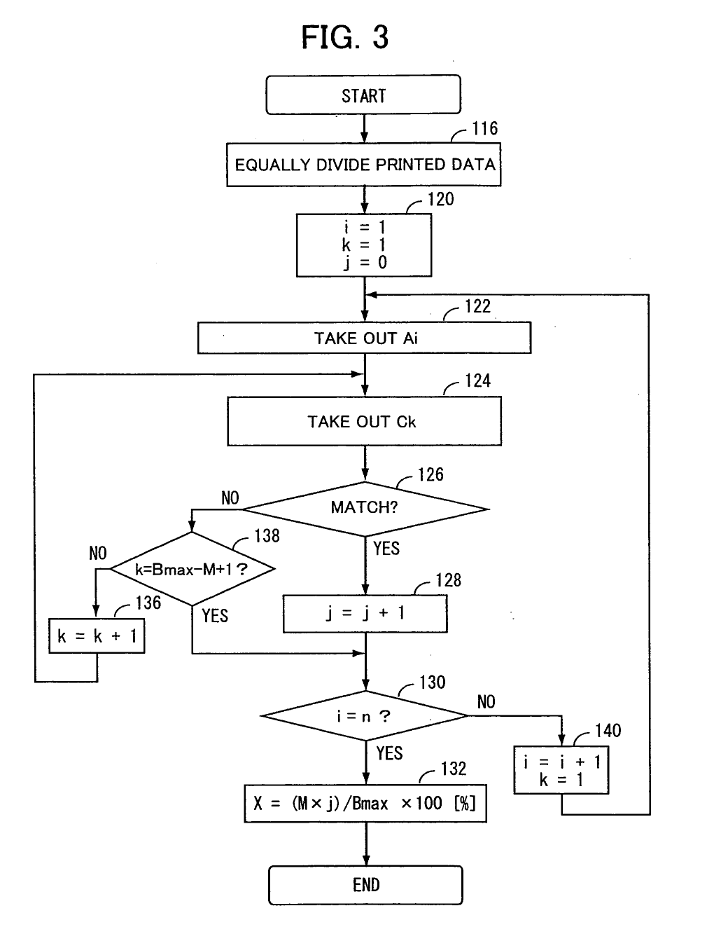

If the determination at step 84 is YES, CPU 52 activates and executes a match rate calculating program shown in FIG. 3, for calculating the match rate. At step 86 shown in FIG. 2, the determination process is performed using the match rate calculated by the match rate calculating program.

Referring to FIG. 3, the match rate calculating program includes a step 116 of equally dividing printed image data stored in HDD 60 into n blocks at every M bytes. In the following, the image data that has been printed and stored in HDD 60 will be referred to as the printed data. Further, the image data as the object of printing corresponding to the print instruction, received at the time of activation of the program shown in FIG. 2, will be referred to as the received print data.

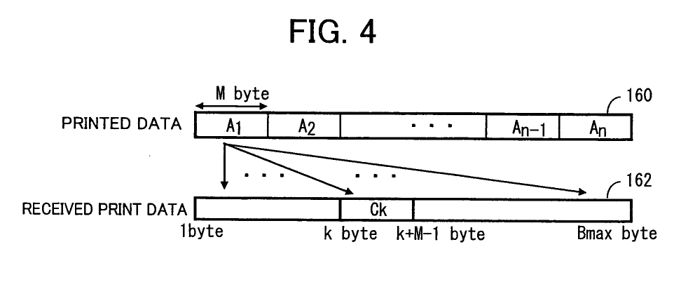

At step 116, the printed data is equally divided as shown in FIG. 4. Each block of printed data 160 shown in FIG. 4 will be hereinafter referred to as a block Ai. The variable i represents an integer value of 1 to n. From the start of printed data, the blocks will be denoted as A₁, A₂, . . . Aₙ₋₁, Aₙ.

The program further includes a step 120 executed after step 116, of inputting 1 to variable i and to a variable k, which will be described later, and inputting 0 to a variable j, which will be described later, indicating the number of matching blocks between the printed data 160 and the received print data 162; a step 122 executed after step 120, of reading block Aᵢ from printed data 160; and a step 124 executed after step 122 of taking out a block including the k-th byte to k+M−1th byte (the block will be hereinafter referred to as a block Ck) of received print data 162.

As shown in FIG. 4, here, the received print data 162 includes information from the 1st byte to Bmax-th byte.

The program further includes a step 126, executed after step 124, of determining whether the block Aᵢ taken out at step 122 and the block Cₖ taken out at step 124 match, and branching the control flow depending on the result of determination. Here, the determination is YES if blocks Aᵢ and Cₖ are fully identical, and it is NO otherwise.

The program further includes a step 128 executed in response to the determination of YES at step 126, of adding 1 to variable j; a step 130 executed after step 128, of determining whether i=n (maximum value) or not, and branching the control flow depending on the result of determination; and a step 132 executed in response to a determination at step 130 that the variable i is the maximum value, of determining the match rate X=M×J/Bₘₐₓ×100[%].

The program further includes a step 138 executed in response to the determination of NO at step 126, of determining whether k=Bₘₐₓ−M+1 (maximum value) or not, and proceeding to step 130 if the variable k is the maximum value; a step 136 executed in response to the determination at step 138 that the variable k is not the maximum value, of adding 1 to k, and returning to step 124; and a step 140 executed in response to the determination at step 130 that variable i is not the maximum value, of adding 1 to i, and inputting 1 to variable k, and returning to step 122.

—Operation—

Image forming apparatus 26 having the above-described structure operates in the following manner.

Referring to FIG. 1, assume that any of the PCs transmitted a print instruction to image forming apparatus 26. The printer driver of this PC transmits, together with the print instruction, the image data as the object of printing, file name of the print data, and the ID and network address of the PC, through network 20 to image forming apparatus 26.

LAN I/F 50 receives the print instruction and informs CPU 52 of the reception. In response, CPU 52 activates the control program for wasteful printing detection shown in FIG. 2. At step 80 shown in FIG. 2, CPU 52 temporarily stores the image data as the object of printing, file name of the data, and the ID and network address of transmission source PC, in RAM 56. Thereafter, at step 84, using the file name stored in RAM 56 as a search key, information related to printed data stored in HDD 60 is searched, and whether or not there is any data of the same file name is determined. Here, it is assumed that the PC transmitted the print instruction of the image data for the first time. The result of determination is, therefore, NO, and at steps 98 and 100, CPU 52 stores the image data as the object of printing, file name of the data, ID and network address of the transmission source PC, and the number of copies to be printed, all in related manner, in HDD 60. The image data as the object of printing is developed to allow printing. CPU 52 transmits the data to printer engine 42 through engine I/F 58, executes printing of the data, and ends the process.

Thereafter, every time image forming apparatus 26 receives a print instruction, the program shown in FIG. 2 is activated.

When a print instruction is received from a different PC, or when a print instruction of image data having a file name different from the last time is received from the same PC, CPU 52 executes the print executing process as described above.

When a print instruction of the same file name is given from the same PC, the process proceeds to step 86, and the program shown in FIG. 3 is executed.

Referring to FIGS. 3 and 4, at step 116 of FIG. 3, CPU 52 reads printed data 160 from HDD 60, and equally divides the printed data 160 into n block, at every M bytes. Thereafter, at steps 122, 124, 126, 138 and 136, CPU 52 reads block C₁ including the information from the 1st byte to the M-th byte of received print data 162, and compares it with block A₁. If they do not match, CPU 52 reads a block C₂, including information from the 2nd to M+1-th byte, shifted 1 byte from block C₁ toward the end of the data, from received print data 162. CPU 52 compares block C₂ with block A₁. In this manner, CPU 52 successively compares the block A₁ of printed data 160 with each of blocks Cₖ of received print data 162 from the start to the end of received print data 162, such as block A₁ and block C₁, block A₁ and block C₂, . . . block A₁ and block C_{Bmax-M+1}. If there is a block Cₖ that matches A₁, 1 is counted at step 128 as the number of matching block. Thereafter, the process proceeds to steps 130, 140 and 122, and CPU 52 performs the same process on the next block A₂.

Otherwise, steps 124, 126, 138 and 136 are repeated until k reaches the maximum value, and then, the same process starts on the next block A₂ through steps 130, 140 and 122.

If comparison with Cₖ is completed for every Aᵢ, determination of YES is made at step 130, and at step 132, CPU 52 determines the match rate X % of received print data 162 with respect to the printed data 160.

Based on the match rate X % calculated in the above-described manner, CPU 52 makes a determination of step 86 of FIG. 2. In the present embodiment, it is assumed that the threshold value a % is determined in advance.

If X<a, CPU 52 performs the print execution process in the same manner as described above. If X≧a, determination at step 86 is YES, and CPU 52 makes a determination of step 88 based on the accumulated number of printed copies. In the present embodiment, the threshold value b is the value obtained by subtracting, from a predetermined value, the number of copies to be printed if the image data as the object of printing received this time is printed.

If the accumulated number of copies is smaller than b, CPU 52 performs the print execution process in the same manner as described above. If the accumulated number of copies is equal to or larger than b, at steps 90 and 92 of FIG. 2, CPU 52 transmits a signal indicating that the print instruction corresponds to wasteful printing, to the network address of the PC as the transmission source, through LAN I/F 50. Further, CPU 52 transmits a signal to the PC to cause a window allowing the user to select activation/inactivation of the print instruction, to be displayed on the display screen.

The printer driver on the PC receives the signal from image forming apparatus 26, and provides a display that the print instruction leads to wasteful printing, and a display of a window allowing the user to select activation/inactivation of the print instruction. The user selects activation/inactivation of the print instruction. The printer driver transmits the user selection to image forming apparatus 26.

After the step 92 of FIG. 2, CPU 52 of image forming apparatus 26 waits for the signal indicating the user selection, from the PC. Receiving the signal of inactivation, determination of NO is made at step 94, and CPU 52 cancels the print instruction and ends the process. If a signal of activation is received, the process proceeds to steps 98 and 100, at which CPU 52 performs the print execution process in the similar manner as described above. CPU 52 stores the print data that has been stored, and the file name of the print data newly in HDD 60, in relation to the ID and network address of the transmission source PC.

As described above, by the image forming apparatus 26 in accordance with the present embodiment, wasteful printing is detected based on the amount of correction of the print data, and hence, wasteful printing can be avoided without requiring troublesome work. Particularly, when a file as an object of printing is formed on a terminal, warning is given to a user who makes minor correction (ratio of correction is small) and prints similar image data time and again for polishing, so that accumulated number of printed copies is large. This is effective to encourage the user to reduce wasteful printing. Reduction of wasteful printing avoids wasteful cost of printing, including cost of ink and paper. Further, according to the image forming apparatus 26 of the present embodiment, wasteful printing is reduced and hence, decrease in work efficiency can be prevented.

### Second Embodiment

—Structure—

The image forming apparatus in accordance with the second embodiment of the present invention is similar to the image forming apparatus 26 in accordance with the first embodiment, and it differs from the image forming apparatus 26 in accordance with the first embodiment in that wasteful printing is permitted for a predetermined number of times. In the image forming apparatus in accordance with the present embodiment, even if a newly received print instruction is determined to result in wasteful printing, printing process is executed immediately in accordance with the print instruction as long as the number of wasteful printing operations is smaller than the predetermined number (for example, 10 times). If the number of wasteful printing operations is equal to or larger than the predetermined number, the image forming apparatus executes a process of giving a notice to that effect to the PC.

The hardware configuration of image forming apparatus in accordance with the present embodiment is the same as the hardware configuration of image forming apparatus 26 in accordance with the first embodiment shown in FIG. 1, except for the following point.

The image forming apparatus in accordance with the present embodiment includes, in place of HDD 60 shown in FIG. 1, an HDD for storing the number of wasteful printing operations, and in this point it is different from image forming apparatus 26 in accordance with the first embodiment.

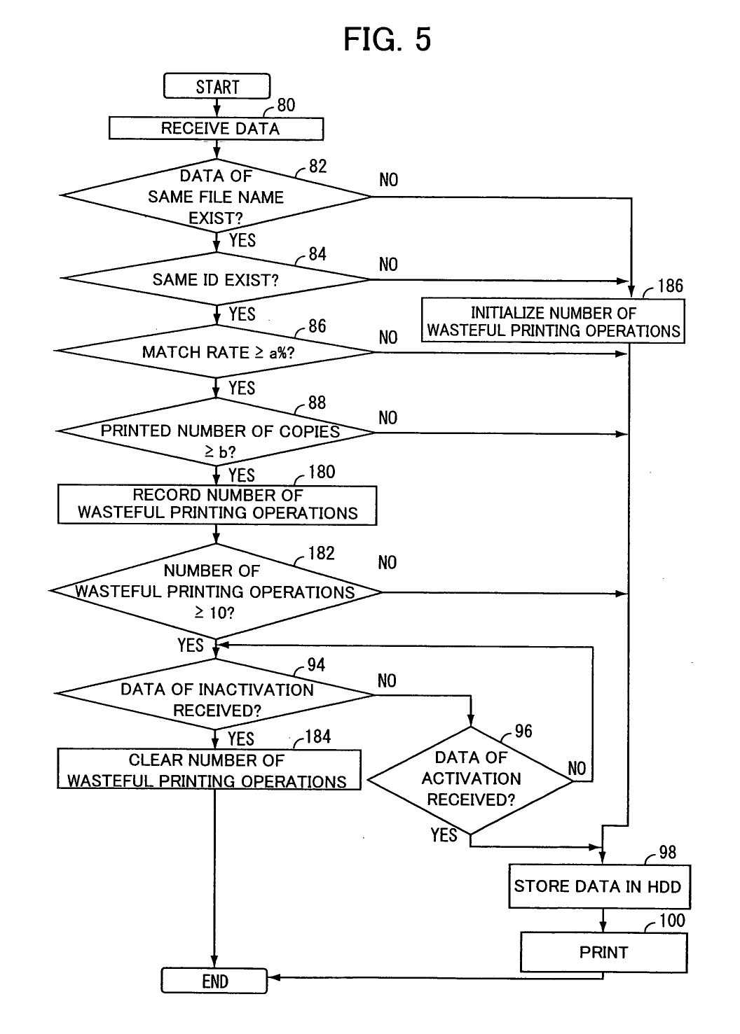

Referring to FIG. 5, the program executed by the CPU of image forming apparatus in accordance with the present embodiment is substantially the same as the program shown in FIG. 2, except for the following points. The program executed by the CPU of the image forming apparatus in accordance with the present embodiment additionally includes a step 186, executed if the result of determination at step 82 or 86 is NO, of ensuring an area for storing the number of wasteful printing operations in a non-volatile memory such as HDD 60 in correspondence with the file name and the ID of transmission source PC that are the same as those of the received file, initializing the area with a prescribed initial value (for example, 0), and then proceeding to step 98. In this point the program differs from the program shown in FIG. 2. The program includes, in place of steps 90 and 92, a step 180 executed in response to a determination of YES at step 88, of adding 1 to the number of wasteful printing operations corresponding to the file name and the ID of transmission source PC of the print data, and a step 182 executed after step 180, of determining if the number of wasteful printing operations corresponding to the file name and the ID is 10 or more and proceeding to step 94 if it is 10 or more, and proceeding to step 98 otherwise. In this point the program differs from the program shown in FIG. 2. Further, the program newly includes a step 184 executed in response to a determination of YES at step 94, of clearing the count number of wasteful printing operations corresponding to the file name and the ID of transmission source PC stored in HDD 60 and ending the process, and in this point also, the program differs from the program shown in FIG. 2.

—Operation—

The operation of the image forming apparatus in accordance with the present embodiment is similar to that of the first embodiment. It is noted, however that, in the first embodiment, a notice of wasteful printing is issued when wasteful printing is detected for the first time, whereas the present embodiment is different in the following points. Specifically, the image forming apparatus in accordance with the present embodiment is different in that the number of wasteful printing operations of data having the same file name and the same ID is counted (FIG. 5, step 180), that a notice of wasteful printing is issued to the same PC if the number of wasteful printing operations reaches 10 or more (step 182) to receive user selection as to whether the print instruction is to be activated/inactivated, and that if the number of wasteful printing operations is smaller than 10, normal print executing process is performed without receiving the user selection as to whether the print instruction is to be activated/inactivated. Specifically, if a print instruction of the data having the same file name is given from the same PC, normal print executing process is performed up to nine times and, from the tenth, a process for receiving user instruction to activate/inactivate the print instruction is executed.

After the number of wasteful printing operations reached 10, the number of wasteful printing operations is counted continuously until the user inactivates the print instruction. In that case, after the 10th print instruction, it follows that the PC displays a window asking user selection of activation/inactivation every time it receives an instruction. When the user inactivates the print instruction, the number of wasteful printing operations is cleared (step 184).

As compared with the first embodiment, in the present embodiment, the frequency of receiving notice of wasteful printing is reduced. Therefore, a more comfortable printing environment is provided for a user who feels it annoying to receive the notice and to make a selection every time he/she instructs repeated printing.

[Modification]

In the first and second embodiments, if a print instruction of data having the same file name is given from the same user, the program, of which control structure is shown in FIG. 2 or FIG. 5, is executed to detect wasteful printing. The present invention, however, is not limited to such an embodiment. Any approach may be taken provided that wasteful printing is detected in consideration of degree of data correction and the number of printed copies. By way of example, HDD 60 may temporarily store the ID and network address of the PC that issued the print instruction of data of interest, under the control of CPU 52, and after the lapse of a prescribed time period, the information may automatically be deleted. By such an approach, the frequency of receiving notice of wasteful printing reduces as compared with the first and second embodiments and, therefore, a more comfortable printing environment is provided for a user who feels it annoying to receive the notice of wasteful printing and to make a selection.

In the second embodiment, the threshold value related to wasteful printing by the same user is set to 10 times, and a notice of wasteful printing is given and related process is performed if the number of wasteful printing operations of the image data having the same file name by the same user reaches 10. The present invention, however, is not limited to such an embodiment. The threshold value may be different from 10.

In the first embodiment described above, the threshold value of accumulated number of printed copies is calculated by subtracting the number of printed copies corresponding to the data of which printing is instructed, from a constant. The present invention, however, is not limited to such an embodiment. The threshold value of accumulated number of printed copies may be a simple constant, and whether the accumulated number of printed data having the same file name and the same PC ID in the past exceeded the threshold value or not may be determined. In that case, the number of copies to be printed of the present data does not have any influence on the determination and, therefore, the operation would be slightly different from that of the embodiments described above. Even such an embodiment is encompassed by the technical scope of the present invention.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus, comprising:
a receiving unit receiving data as an object of printing from a terminal;
a printer printing the data as the object of printing;
a first determining unit coupled to said receiving unit and said printer, for determining, by comparing contents of new data as the object of printing newly received by said receiving unit and contents of printed data having the same file name as said new data and having the same identifier of a transmission source terminal as said new data, among data already printed by said printer, whether said new data is to be printed immediately or not; and
a print controller connected to said printer and said first determining unit, for executing, depending on whether it is determined by said first determining unit that said new data is not to be printed immediately, a prescribed process for determining whether printing of said new data is to be executed or not, and controlling said printer in accordance with the result of the process.

2. The image forming apparatus according to claim 1, wherein
said first determining unit includes
a storage unit coupled to said printer, for storing print history as a combination of data already printed by said printer, a file name of the data and an identifier of a terminal as a transmission source of the data, and
a second determining unit coupled to said receiving unit and said storage unit, for determining, by comparison between contents of said new data and of the printed data having the same file name and the same identifier of transmission source terminal as said new data among the print history stored in said storage unit, whether or not said new data is to be printed immediately.

3. The image forming apparatus according to claim 1, further comprising a control unit connected to said printer and said first determining unit, for causing said printer to print said new data, in response to a determination by said first determining unit that said new data is to be printed immediately.

4. The image forming apparatus according to claim 1, wherein
said first determining unit includes
a match rate calculating unit coupled to said receiving unit and said printer, for calculating match rate between contents of said new data and contents of printed data having the same file name as said new data and having the same identifier of the transmission source terminal as said new data, among the data already printed by said printer, and
a unit coupled to said match rate calculating unit, for determining whether or not said new data is to be printed immediately, depending on whether the match rate calculated by said match rate calculating unit is equal to or higher than a prescribed threshold value.

5. The image forming apparatus according to claim 1, wherein
said printer controller includes
a transmitting unit coupled to said first determining unit, for transmitting, in response to a determination by said first determining unit that said new data is not to be printed immediately, a signal inquiring whether printing of said new data is to be executed or not, to the transmission source terminal of said new data, and
a control unit coupled to said printer, for controlling said printer in accordance with an instruction returned from said transmission source terminal in response to said signal.

6. The image forming apparatus according to claim 1, wherein
said printer controller includes
an accumulated number calculating unit, coupled to said printer and said first determining unit, for calculating an accumulated number of printed copies of the printed data having the same file name as said new data and the same identifier of the transmission source terminal as said new data, among the data already printed by said printer, in response to a determination by said first determining unit that said new data is not to be printed immediately,
a second determining unit coupled to said accumulated number calculating unit for determining whether or not said new data is to be printed immediately, depending on whether said accumulated number calculated by said accumulated number calculating unit is larger than a prescribed threshold value or not,
a transmitting unit coupled to said second determining unit, for transmitting, in response to a determination by said second determining unit that said new data is not to be printed immediately, a signal inquiring whether printing of said new data is to be executed or not, to the transmission source terminal of said new data, and
a control unit coupled to said printer, for controlling said printer in accordance with an instruction returned from said transmission source terminal in response to said signal.

7. The image forming apparatus according to claim 1, wherein
said printer controller includes
a memory,
an area ensuring unit coupled to said receiving unit and said memory, for ensuring, in response to reception by said receiving unit of a combination of a certain Me name and a certain identifier of a transmission source terminal, an area corresponding to the combination of the file name and the identifier of the transmission source terminal, and initializing said area with a prescribed value,
an adding unit coupled to said first determining unit and said memory, for adding, in response to a determination by said first determining unit that said new data is not to be printed immediately, a prescribed constant to a value stored in a first area ensured in said memory in association with the Me name of the data and the identifier of the transmission source terminal of the data,
a second determining unit coupled to said memory, for determining whether or not the value in said first area has exceeded a threshold value,
a transmitting unit coupled to said second determining unit, for transmitting, in response to a determination by said second determining unit that said value has exceeded said threshold value, a signal inquiring whether printing of said new data is to be executed or not, to the transmission source terminal of said new data, and
a control unit coupled to said printer, for controlling said printer in accordance with an instruction returned from said transmission source terminal in response to said signal.

8. The image forming apparatus according to claim 7, wherein
said printer controller further includes
a re-initializing unit coupled to said memory, for re-initializing the value of said first area with said prescribed value, in response to an instruction to suspend printing returned from said transmission source terminal in response to said signal.

9. The image forming apparatus according to claim 4, wherein
said match rate calculating unit includes
a selecting unit coupled to said receiving unit and said printer, for successively selecting each of printed data having the same file name as said new data and having the same identifier of a transmission source terminal as said new data, among the data already printed by said printer,
a dividing unit coupled to said selecting unit, for equally dividing data selected by said selecting unit into blocks of a prescribed size,
a match determining unit coupled to said dividing unit, for determining, for each of said blocks divided by said dividing unit, whether or not a matching block exists in said new data, and
a unit coupled to said selecting unit, said dividing unit and said match determining unit, for calculating, as said match rate, ratio between a total number of blocks divided by said dividing unit and the number of blocks that are determined by said match determining unit to have matching block in said new data, for the data selected by said selecting unit.

10. An image forming apparatus, comprising:
receiving means for receiving data as an object of printing from a terminal;
printing means for printing the data as the object of printing;
first determining means for determining, by comparing contents of new data as the object of printing newly received by said receiving means, and contents of printed data having the same file name as said new data and having the same identifier of a transmission source terminal as said new data, among data already printed by said printing means, whether said new data is to be printed immediately or not; and
first print control means for executing, depending on whether it is determined by said first determining means that said new data is not to be printed immediately, a prescribed process for determining whether printing of said new data is to be executed or not, and controlling said printing means in accordance with the result of the process.

11. The image forming apparatus according to claim 10, wherein
said first determining means includes
match rate calculating means for calculating match rate between contents of said new data and contents of printed data having the same file name as said new data and having the same identifier of the transmission source terminal as said new data, among the data already printed by said printing means, and
means for determining whether or not said new data is to be printed immediately, depending on whether the match rate calculated by said match rate calculating means is equal to or higher than a prescribed threshold value.

12. The image forming apparatus according to claim 10, wherein
said printer control means includes
transmitting means for transmitting, in response to a determination by said first determining means that said new data is not to be printed immediately, a signal inquiring whether printing of said new data is to be executed or not, to the transmission source terminal of said new data, and
means for controlling said printing means in accordance with an instruction returned from said transmission source terminal in response to said signal.

13. The image forming apparatus according to claim 10, wherein
said printer control means includes
accumulated number calculating means for calculating an accumulated number of printed copies of the printed data having the same file name as said new data and the same identifier of the transmission source terminal as said new data, among the data already printed by said printing means, in response to a determination by said first determining means that said new data is not to be printed immediately,
second determining means for determining whether or not said new data is to be printed immediately, depending on whether said accumulated number calculated by said accumulated number calculating means is larger than a prescribed threshold value or not,
transmitting means, for transmitting, in response to a determination by said second determining means that said new data is not to be printed immediately, a signal inquiring whether printing of said new data is to be executed or not, to the transmission source terminal of said new data, and
means for controlling said printing means in accordance with an instruction returned from said transmission source terminal in response to said signal.

14. The image forming apparatus according to claim 10, wherein
said printer control means includes
a memory,
area ensuring means for ensuring, in response to reception by said receiving means of a combination of a certain file name and a certain identifier of a transmission source terminal, an area corresponding to the combination of the file name and the identifier of the transmission source terminal, and initializing said area with a prescribed value,
adding means for adding, in response to a determination by said first determining means that said new data is not to be printed immediately, a prescribed constant to a value stored in a first area ensured in said memory in association with the file name of the data and the identifier of the transmission source terminal of the data,
second determining means for determining whether or not the value in said first area has exceeded a threshold value,
transmitting means for transmitting, in response to a determination by said second determining means that said value has exceeded said threshold value, a signal inquiring whether printing of said new data is to be executed or not, to the transmission source terminal of said new data, and
means for controlling said printing means in accordance with an instruction returned from said transmission source terminal in response to said signal.

15. The image forming apparatus according to claim 14, wherein
said printer control means further includes
re-initializing means for re-initializing the value of said first area with said prescribed value, in response to an instruction to suspend printing returned from said transmission source terminal in response to said signal.

16. The image forming apparatus according to claim 11, wherein
said match rate calculating means includes
selecting means for successively selecting each of printed data having the same file name as said new data and having the same identifier of a transmission source terminal as said new data, among the data already printed by said printing means,
dividing means for equally dividing data selected by said selecting means into blocks of a prescribed size,
match determining means for determining, for each of said blocks divided by said dividing means, whether or not a matching block exists in said new data, and
means for calculating, as said match rate, ratio between a total number of blocks divided by said dividing means and the number of blocks that are determined by said match determining means to have a matching block in said new data, for the data selected by said selecting means.

17. An image forming method, comprising the steps of
receiving data as an object of printing from a terminal;
determining, by comparing contents of received data as an object of printing received at said step of receiving with contents of printed data having the same file name as said received data and having the same identifier of a transmission source terminal as said received data among the data already printed by a printer, whether or not said received data is to be printed immediately or not; and
executing, depending on whether it is determined at said step of determining that said received data is not to be printed immediately, a prescribed process for determining whether printing of said received data is to be executed or not, and printing said received data in accordance with the result of the process.

18. The image forming method according to claim 17, wherein
said step of determining includes the steps of:
calculating a match rate between contents of said received data and contents of printed data having the same file name as said received data and having the same identifier of the transmission source terminal as said received data, among the data already printed by said printer, and
determining whether or not said received data is to be printed immediately, depending on whether the match rate calculated at said step of calculating or match rate is equal to or higher than a prescribed threshold value.

19. An image forming program causing, when executed by a computer, said computer to execute an image forming method including the steps of:
receiving data as an object of printing from a terminal;
determining, by comparing contents of received data as an object of printing received at said step of receiving with contents of printed data having the same file name as said received data and having the same identifier of a transmission source terminal as said received data among the data already printed by a printer, whether or not said received data is to be printed immediately or not; and
executing, depending on whether it is determined at said step of determining that said received data is not to be printed immediately, a prescribed process for determining whether printing of said received data is to be executed or not, and printing said received data in accordance with the result of the process.

20. The image forming program according to claim 19, wherein
said step of determining includes the steps of
calculating a match rate between contents of said received data and contents of printed data having the same file name as said received data and having the same identifier of the transmission source terminal as said received data, among the data already printed by said printer, and
determining whether or not said received data is to be printed immediately, depending on whether the match rate calculated at said step of calculating a match rate is equal to or higher than a prescribed threshold value.
